(19) United States
(12) Patent Application Publication
(10) Pub. No.: US 2024/0326017 A1
(43) Pub. Date: Oct. 3, 2024

(54) FIBER-ENCAPSULATED HYBRID MATERIALS FOR CAPTURE OF CARBON DIOXIDE

(71) Applicants: UT-Battelle, LLC, Oak Ridge, TN (US); THE TRUSTEES OF COLUMBIA UNIVERSITY IN THE CITY OF NEW YORK, New York, NY (US); Cornell University, Ithaca, NY (US)

(72) Inventors: Michelle K. Kidder, Clinton, TN (US); Ah-Hyung Park, New York, NY (US); Yong L. Joo, Ithaca, NY (US)

(21) Appl. No.: 18/621,503

(22) Filed: Mar. 29, 2024

Related U.S. Application Data
(60) Provisional application No. 63/456,587, filed on Apr. 3, 2023.
(60) Provisional application No. 63/456,014, filed on Mar. 31, 2023.

(51) Int. Cl. B01J 20/28; B01D 39/16; B01D 53/02; B01D 53/62; B01J 20/22; B01J 20/26; D01F 8/16; D01F 8/18

(52) U.S. Cl. CPC B01J 20/28023; B01D 39/1623; B01D 53/02; B01D 53/62; B01J 20/223; B01J 20/262; B01J 20/264; D01F 8/16; D01F 8/18; B01D 2239/0216; B01D 2239/0407; B01D 2239/0428; B01D 2239/0631; B01D 2257/504; B01D 2258/0283; B01J 2220/445; B01J 2220/46

(57) ABSTRACT

An encapsulated fiber composition (typically resulting from an electrospinning process) containing: (i) a lengthwise core portion of the fiber comprising an amine-containing material for adsorbing carbon dioxide; and (ii) a lengthwise sheath portion of the fiber surrounding said lengthwise core portion, wherein the lengthwise sheath portion comprises a microporous polymer. Particularly described are fiber compositions containing a nanoparticle organic hybrid material (NOHM) or organoamine or amine-containing sorbent (e.g., PEI or TEPA) in a core portion of the fiber and a polymer of intrinsic microporosity (PIM), such as PIM-1 or PIM-2, or PAN or PAN combined with a polysilazane or polysiloxane in a sheath portion of the fiber. A method of using the fiber composition to capture carbon dioxide, such as from ambient air, is also described.

### CROSS REFERENCE TO RELATED APPLICATION

The present application claims benefit of U.S. Provisional Application No. 63/456,014, filed on Mar. 31, 2023, and U.S. Provisional Application No. 63/456,587, filed on Apr. 3, 2023, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

This invention generally relates to compositions and methods of use for the capture of carbon dioxide gas. The invention more particularly relates to fibrous compositions useful in carbon dioxide capture.

### BACKGROUND

Carbon dioxide absorption materials should possess high thermal stability, high CO₂ capture capacity, low specific heat capacities, and can be designed for negligible vapor pressure, be selective and potentially reject water for optimal working efficiencies. Sorbents, including amines, such as polyethyleneimine (PEI), tetraethylpentamine (TEPA), triethyltetramine (TETA) and silica with physisorbed, ionically or covalently tethered amines (PEI, TETA, or TEPA), such as nanoparticle organic hybrid materials (NOHMS), are used for CO₂ capture with high selectivity. NOHMS advantageously have low vapor pressure in comparison to most solvents. NOHMs typically feature a nanometer-scale core, most often SiO₂, although examples of γ-Fe₂O₃, ZnO, TiO₂, platinum, gold, palladium, and rhodium are known. Attached to the core is a CO₂-adsorbing molecular or polymeric corona (canopy) grafted to the core by either ionic or covalent linkages.

However, a particular problem encountered with amine sorbents and composites, such as NOHMs, is that they are generally highly viscous, which limits handling and practical use and also creates mass transfer limitation. Currently, PEI, TEPA, TETA, and NOHMs also have the drawback of absorbing water during CO₂ capture, which results in parasitic energy consumption during pressure/temperature swing desorption. Thus, there remains an unmet need to overcome these issues of NOHMs in order to more efficiently and effectively use NOHMs.

Carbon capture and sequestration technologies are an attainable solution while renewable energy generation and storage mature to the point of replacing fossil fuel use, although issues of scalability prevent widespread adoption on the megaton to gigaton scale of CO₂ removal. While many technologies are under development to take advantage of high-concentration sources of carbon emissions from existing sources (e.g., flue gases) using, for example, liquid-phase amine solutions, solid-supported amines, zeolites, carbon nanotubes, metal-organic frameworks, alkali metal bases, and pressure/temperature-swing adsorption processes, ambient-air sequestration remains the greater challenge. The low concentration of CO₂ in ambient air relative to other gases requires the processing of extremely large volumes of air to remove appreciable amounts of CO₂, which is highly energy intensive.

Additionally, the sorbent material should exhibit a high degree of selectivity toward carbon dioxide. Amine-based sorbents are widely used chemisorption capture agents due to the excellent Lewis acid-base reactivity with carbon dioxide, forming an ammonium carbamate (in dry conditions) and/or ammonium bicarbonate (in wet conditions) to chemically bind CO₂. Regeneration is then achieved by raising the temperature of the sorbent, typically above 100° C., to decompose the carbamate or bicarbonate back to amine, and liberating an equivalent of CO₂ in the process. However, the hygroscopic or solution-phase nature of many amine sorbents requires considerable energy to disrupt the strong hydrogen bonding network during regeneration. Additionally, amine sorbents tend to suffer from thermal and/or oxidative degradation at regeneration temperatures, with primary amines (the most reactive to CO₂) being the most susceptible. Herein lie two crucial design criteria precluding the adoption of a carbon capture solution: the technology should be able to selectively reject water to avoid forming these intermolecular hydrogen bonds, and the pressure drop through the sorbent should be minimal while still maintaining high amine densities for efficient capture.

### SUMMARY

The present invention is foremost directed to an encapsulated fiber composition that contains an interior CO₂ adsorption portion encapsulated by an exterior microporous layer developed through electrospinning processes. By virtue of this design, the encapsulated fiber composition overcomes several of the problems encountered with CO₂ sorbents of the art, particularly PEI, TEPA, TETA and NOHMs. The described fiber composition circumvents the viscous flow issue commonly encountered with PEI, TEPA, TETA and NOHMs, thereby simplifying the handling and mass transfer. The described fiber composition also advantageously selectively rejects water during CO₂ capture, which significantly reduces the parasitic energy consumption during pressure/temperature swing desorption. The fiber composition is also advantageously thermally stable at the temperatures used for regeneration of the core sorbent, 40, 50, 60, 70, 80, 90, 100, 110, 120° C. Fiber morphology, including fiber diameter can be controlled through solvent and electrospinning method developments, which enables concentration of the sorbent in the core and also overcomes sorption kinetics due to limitations from diffusion and mass transport. Moreover, the fiber design has application for DAC filter systems, such as HVAC, and can be tuned to minimize the pressure drop and will better permit its deployments in both open and closed air systems.

More particularly, the encapsulated fiber composition contains at least (or exclusively) the following parts: (i) a lengthwise core portion of the fiber comprising an amine-containing material for adsorbing carbon dioxide; and (ii) a lengthwise sheath portion of the fiber surrounding said lengthwise core portion, wherein the lengthwise sheath portion comprises a microporous or ceramic coated polymer. In some embodiments, the amine-containing material is or includes an organoamine molecule, e.g., monoethanolamine, diethanolamine, N-methyldiethanolamine, diisopropylamine, triethanolamine, piperazine, homopiperazine, triethylene tetramine, tetraethylpentamine, diethylamine, diisopropylamine, tert-butylamine, 2-(t-butylamino) ethanol, pipecolic acid, piperidine, 2-piperidine-methanol, 2-piperidine-ethanol, 2-amino-2-methyl-1,3-propanediol, 2-amino-2-ethyl-1,3-propanediol, 2-amino-2-methyl-1-propanol, 1,8-p-menthanediamine, 2-amino-2-methylpropionic acid, 2-amino-2-phenylpropionic acid, pyridine, pyrazine, polyethyleneimine (PEI), guanidine-containing molecules, and mixtures thereof. In other embodiments, the amine-containing material comprises a nanoparticle organic hybrid material (NOHM) containing a nanoparticle core attached to an amine-containing canopy, wherein the nanoparticle core may be a metal oxide, such as silicon dioxide, and the amine-containing canopy may be or include a molecule of the formula: H₂N—CH₂CH₂—NH—CH₂CH₂(NH—CH₂CH₂)ₙ—NH₂, wherein n is 0-12, or a branched polyethyleneimine (PEI) polymer with molecular weight of 800 daltons or greater. In some embodiments, the microporous polymer contains aromatic rings, or the microporous polymer contains a dibenzodioxane fused ring system, or the microporous polymer contains a spirobisindane system, or the microporous polymer comprises a polymer of intrinsic microporosity (PIM), such as PIM-1 or PIM-2, or the microporous polymer contains nitrile groups, such as in polyacrylonitrile (PAN), or the microporous polymer contains a mixture of PAN and an organopolysilazane (OPSZ) for ceramic-like coating.

In another aspect, the present disclosure is directed to a method for capturing carbon dioxide by contacting a source of carbon dioxide with an encapsulated fiber composition as described above. In some embodiments, the source of carbon dioxide is air. In other embodiments, the source of carbon dioxide is a combustion source. The source of carbon dioxide may also be a natural gas emission, commercial biomass fermenter (e.g., ethanol fermentation), flue gas, or commercial carbon dioxide-methane separation process for gas wells.

### BRIEF DESCRIPTION OF THE FIGURES

FIGS. 1a-1d. FIG. 1a shows the chemical structure of NOHM-I-TEPA sorbent. FIG. 1b shows the chemical structure of NOHM-I-PEI sorbent. FIG. 1c is a photograph showing the physical form of NOHM-I-TEPA. FIG. 1d is a photograph showing the physical form of NOHM-I-PEI.

FIGS. 2a-2e. FIG. 2a shows a scheme for synthesizing the PIM-1 microporous polymer. FIGS. 2b and 2c are nitrogen (N₂) sorption isotherms and pore size distribution graphs (H-K method), respectively, for neat PIM-1. FIGS. 2d and 2e are nitrogen isotherms and pore size distribution graphs (H-K method), respectively, for electrospun pure PIM-1 nanofibers.

FIGS. 3a-3c. Scanning electron microscope (SEM) image (FIG. 3a), EDS elemental mapping of nitrogen (FIG. 3b), and EDS elemental mapping of silicon (FIG. 3c) for a PIM-1/NOHMs nanofiber mat.

FIGS. 4a-4c. Transmission electron microscope (TEM) micrographs of Microtomed and Uranyl acetate-stained pure PIM-1 fibers (FIG. 4a), PIM-1/NIPEI composite fibers (FIG. 4b), and PIM-1/NITEPA composite fibers (FIG. 4c).

FIGS. 5a-5e. FIG. 5a (top four panels) are photographs showing the morphology of PIM-1 fibers containing NOHM-I-PEI, NOHM-I-TEPA, PEI, or TEPA as the core amine-containing sorbent, with PIM-1 as sheath. FIG. 5a (bottom four panels) are photographs showing the contact angle for hydrophobicity of PIM-1 fibers containing NOHM-I-PEI, NOHM-I-TEPA, PEI, or TEPA as the core amine-containing sorbent, with PIM-1 as sheath. FIGS. 5b and 5c are graphs showing the capture performance for these fibers for 400 ppm CO₂/N₂ and 100% CO₂, respectively. FIGS. 5d and 5e are graphs showing thermal decomposition for the PEI- based fibers and TEPA-based fibers, respectively.

FIGS. 6a-6f. FIGS. 6a-6d are photographs showing the morphology of fibers containing different levels of loading of NIPEI sorbent (wt % 20, 40%, 60%, and 80%, respectively) with a PAN-OPSZ (90:10) sheath. FIG. 6e is a graph showing the surface area of the composite fibers along with optimal pore volume as a function of NOHM-I-PEI weight loading of the fiber, I refers to PEI ionically tethered to the silica core. FIG. 6f is a graph showing capture performance of the composite fibers as a function of NOHM-I-PEI weight loading.

FIGS. 7a-7j. FIGS. 7a-7f are SEM images of PAN/OPSZ/NIPEI fiber mats with varying PAN:OPSZ ratios (90:10, 80:20, and 70:30) at lower magnification (top row, FIGS. 7a-7c) and higher magnification (bottom row, FIGS. 7d-7f), inset is of the contact angle of the fiber indication hydrophobicity. FIG. 7g is a histogram of fiber diameters of mats made with varying PAN:OPSZ ratios (90:10, 80:20, and 70:30). FIG. 7h is a graph plotting the pressure drop of PAN:OPSZ fiber mat with fixed area loading (2 mg/cm²) for PAN:OPSZ ratios of 70:30 and 90:10 and 50% weight NOHM-I-PEI. FIG. 7i is a graph plotting 5 hour CO₂ adsorption under 1 atm CO₂ at 25° C. for PAN:OPSZ ratios of 70:30, 80:20, and 90:10 with NOHM-I-PEI 50 weight percent. FIG. 7j is a graph showing results of a multi-cycle CO₂ capture test under 1 atm CO₂, 25° C. for 1 h (Regeneration: N₂ at 120° C. for 1 h) for PAN:OPSZ ratios of 70:30, 80:20, and 90:10 and 50% weight loading NOHM-I-PEI (also referred to as NIPEI).

FIGS. 8a-8b. FIG. 8a is a graph showing results of chemical characterizations of PAN/OPSZ composite fibers via solid-state ¹H-NMR. FIG. 8b is a graph showing results of chemical characterizations of each component, PAN, OPSZ, NIPEI and PAN/OPSZ/NIPEI composite fibers via FT-IR.

FIGS. 9a-9b. CO₂, 400 ppm, 20% O₂, with N₂ balance, breakthrough tests of PAN/OPSZ/NIPEI composite fibers in dry condition (FIG. 9a) and humid (RH=70%) condition (FIG. 9b).

FIG. 10. A schematic depicting an exemplary electrospinning process for producing the encapsulated fiber compositions described herein.

### DETAILED DESCRIPTION

In one aspect, the present disclosure is directed to an encapsulated fiber composition in which each fiber contains: (i) a lengthwise core portion of the fiber containing an amine- containing material for adsorbing carbon dioxide; and (ii) a lengthwise sheath portion of the fiber surrounding the lengthwise core portion, wherein the lengthwise sheath portion contains a microporous polymer. The lengthwise sheath portion of the fiber surrounds the lengthwise core portion all along the length of the fiber. The fiber is typically round along its axial length but may instead have one or more vertices, such as a polygonal or flat-ribbon shape. The fiber is typically at least 1 mm in length, or may be at least 5 mm or 1 cm in length, or a length within a range within any of these values. The fibers typically have a thickness of at least 0.1 microns, or may be at least 0.2 microns, 0.5 microns, 1 micron, 2 microns, or 5 microns, or a width within a range within any of these values. As further discussed below, the encapsulated fiber is typically produced by an electrospinning process (i.e., the encapsulated fiber can be considered an electrospun encapsulated fiber).

The lengthwise core portion of the fiber (component (i)) contains an amine-containing material for adsorbing carbon dioxide. In a first set of embodiments, the amine-containing material is or includes an organoamine molecule. The organoamine molecule often contains at least one primary or secondary amine, and may or may not include a tertiary amine. Some examples of organoamine molecules include monoethanolamine, diethanolamine, N-methyldiethanolamine, diisopropylamine, triethanolamine, piperazine, homopiperazine, triethylene tetramine, tetraethylpentamine, diethylamine, diisopropylamine, tert-butylamine, 2-(t-butylamino) ethanol, pipecolic acid, piperidine, 2-piperidine-methanol, 2-piperidine-ethanol, 2-amino-2-methyl-1,3-propanediol, 2-amino-2-ethyl-1,3-propanediol, 2-amino-2-methyl-1-propanol, 1,8-p-menthanediamine, 2-amino-2-methylpropionic acid, 2-amino-2-phenylpropionic acid, polyethyleneimine, pyridine, pyrazine, guanidine-containing molecules, amine-containing polymers, and mixtures thereof. In a second set of embodiments, the amine-containing material is or includes a nanoparticle organic hybrid material (NOHM), which contains a nanoparticle core (typically a metal oxide, such as silicon dioxide, aluminum oxide, or iron oxide) attached to an amine-containing canopy. In some embodiments, the amine-containing canopy can be any of the organoamine molecules described above. In other embodiments, the amine-containing canopy is or includes a molecule of the formula: H₂N—CH₂CH₂—NH—CH₂CH₂(NH—CH₂CH₂)ₙ—NH₂, wherein n is 0-12 (or more particularly, n is 1-12, 2-12, 3-12, 4-12, 1-6, 2-6, 3-6, or 4-6). In other embodiments, the amine-containing canopy is or includes a branched polyethyleneimine (PEI), which may have a molecular weight of precisely or at least, for example, 0.5 kDa, 1 kDa, 2 kDa, 5 kDa, 10 kDa, 20 kDa, or 50 kDa, or a molecular weight within a range bounded by any two of the foregoing values. In a third set of embodiments, the amine-containing material is or includes an amine-based nanoparticle suspension (nanofluid), which is typically a mixture of nanoparticles (typically metal oxide, such as silicon oxide) and an amine-containing solvent. NOHMs and amine-based nanofluids are well known in the art, such as described in W. Yu et al., Nanoscale, 11, 17137, 2019, which is incorporated herein by reference. Any of the above amine-containing materials may also be combined as a mixture in the core.

The lengthwise sheath portion of the fiber (component (ii)) surrounds the lengthwise core portion described above. The lengthwise sheath portion is or includes a microporous polymer. The microporous polymer contains micropores, which corresponds to a pore size within a range of 0.1-2.5 nm or 0.5-2.5 nm, or more particularly, 0.1-2 nm, 0.2-2 nm, 0.5-2 nm, 0.1-1.5 nm, 0.2-1.5 nm, 0.5-1.5 nm, or 0.1-1 nm. In some embodiments, all (i.e., 100%) of the pores of the microporous polymer have a pore size within any of the foregoing ranges. In other embodiments, at least or greater than 70%, 80%, 90%, or 95% of the pores of the microporous polymer have a pore size within any of the foregoing ranges. Microporous polymers are well known in the art, such as described in, for example, P. M. Budd et al., Materials Today, 7(4), 40-46, April 2004, which is herein incorporated by reference. In addition to the above properties, the microporous polymer should be amenable to being dissolved in an organic solvent and spun into fibers. The microporous polymer should also be able to selectively reject water. The microporous polymer should also be able to permit the passage of carbon dioxide to a substantially greater extent than other gases, such as any one or more of nitrogen, oxygen, methane, and hydrogen.

In some embodiments, the microporous polymer contains aromatic rings. The aromatic rings are typically benzene rings or fused carbocyclic aromatic ring systems, but may, in some embodiments, be or include heteroaromatic rings (e.g., pyridine, pyrazine, pyrrole, imidazole, or thiophene rings) or fused heteroaromatic ring systems. The microporous polymer may alternatively or in addition contain aliphatic or saturated carbocyclic or heterocyclic rings (e.g., cyclohexyl, cyclopentyl, piperidinyl, or pyrrolidinyl). In some embodiments, the microporous polymer contains a dioxane or dibenzodioxane fused ring system. In further or alternative embodiments, the microporous polymer contains a spirobisindane ring system. In further or alternative embodiments, the microporous polymer is or includes a polymer of intrinsic microporosity (PIM), such as a PIM-1 or PIM-2 polymer, as well known in the art (see, e.g., Budd et al., Ibid.). In further or alternative embodiments, the microporous polymer contains a porphyrin or phthalocyanine component. In further or alternative embodiments, the microporous polymer is or includes a metal-organic microporous material or framework (e.g. a MOF or coordination polymer material). In further or alternative embodiments, the microporous polymer includes nitrile groups, or the microporous polymer is or includes polyacrylonitrile (PAN). The PAN may be a homopolymer of PAN or a copolymer containing a segment or block of PAN and one or more segments or blocks of another type of polymer, such as polystyrene or a polyvinyl ester (e.g., polymer of vinyl acetate, methyl methacrylate, or methyl acrylate). In further or alternative embodiments, the microporous polymer is or includes PAN in admixture with a silicon-containing material, such as a polysilazane or polysiloxane, or more particularly, an organopolysilazane (OPSZ) or organopolysiloxane, all of which are all well known in the art. As well known in the art, polysilazanes contain silicon-nitrogen bonds, or more particularly, the —Si—N—Si—N— motif, whereas polysiloxanes contain silicon-oxygen bonds. In further or alternative embodiments, the microporous polymer includes fluorine atoms (i.e., the microporous polymer is fluorinated). When hydrocarbon groups are present in any of these materials, the materials may be denoted with prefix “organo”. Notably, any of the exemplary embodiments for component (i) provided above can be combined with any of the exemplary embodiments for component (ii) provided above.

The core and sheath portions of the fiber can be included in the fiber in any suitable weight ratio. In embodiments, the core to sheath weight ratio is precisely, about, or at least, for example, 10:90, 20:80, 30:70, 40:60, 45:55, 50:50, 55:45, 60:40, 70:30, 80:20, or 90:10, or a weight ratio within a range bounded by any two of the foregoing ratios. In the case where the sheath is a mixture of a nitrile-containing polymer (e.g., PAN) and a silicon-containing material (e.g., OPSZ), the PAN:OPSZ weight ratio may be precisely, about or at least for example, 10:90, 20:80, 30:70, 40:60, 45:55, 50:50, 55:45, 60:40, 70:30, 80:20, or 90:10, or a weight ratio within a range bounded by any two of the foregoing ratios.

The encapsulated fiber composition described above can be produced by methods well known in the art. In typical embodiments, the fiber composition is prepared by a fiber spinning method, such as an electrospinning or wet spinning method, all of which are well known in the art. The core and sheath components are typically dissolved in a solvent to form a solution, and the solution is then spun to form the fiber through monoaxially, co-axially or tri-axial electrospinning methods found in the art. The fiber is typically removed of solvent before use. Any of the weight ratios of core to sheath components, as provided above, may be used in the method. Co-axial and tri-axial fiber spinning techniques can provide core sheath nano-fiber fabrications such as that found in Snetkov, et. al, Mater. Adv., 2022, 3, 4402, but requires development of solvent formulations, air speed, or applied voltage, where a spinneret of 2 or 3 needles with different diameters with different stock solutions for the core and sheath each, are placed coaxially or triaxially to each other. The polarity of solvents can permit migration of the selected material to the interior, core or exterior, and sheath encapsulation such that the materials do not co-diffuse as mixtures of the two solvents containing (1) polymer and (2) amine sorbent into a solid fiber.

In another aspect, the present disclosure is directed to a method of capturing carbon dioxide (CO₂) from a gaseous source using the fiber composition described above. In the method, the gaseous source is contacted with the fiber composition. In some embodiments, before the gaseous source is contacted with the fiber composition, the gaseous source is processed by, for example, removing certain contaminating species (e.g., NOx or SOx), or by reducing the moisture content (humidity level) of the gas, or by substantially removing one or more gases other than carbon dioxide (e.g., nitrogen, oxygen, methane, ethane, ethylene, carbon monoxide, methanol, ethanol, formaldehyde, or hydrogen sulfide). During contact, the carbon dioxide from the gaseous source selectively passes through the sheath portion of the microporous fiber for the carbon dioxide to contact the fiber core where the carbon dioxide reacts with the amine-containing sorbent at the interior core (e.g., by formation of a carbamate bond or bicarbonate or carbonate product). The gaseous source can be any volume of gas containing carbon dioxide. The gaseous source can be, for example, ambient air, a combustion source (e.g., from burning of fossil fuels in an engine or generator), waste gas from an industrial or commercial process, flue gas from a power plant, exhaust from an engine, a natural gas emission, commercial biomass fermenter (e.g., ethanol fermentation), commercial carbon dioxide-methane separation process for gas wells, or sewage or landfill gas. The gaseous source may be a pure or substantially pure source of carbon dioxide or may contain carbon dioxide with appreciable amounts of one or more other gases, e.g., nitrogen, oxygen, one or more hydrocarbons (e.g., methane, ethane, or ethylene), or any other gaseous species mentioned above.

Examples have been set forth below for the purpose of illustration and to describe certain specific embodiments of the invention. However, the scope of this invention is not to be in any way limited by the examples set forth herein.

### EXAMPLES

### Overview

In particular aspects, the technologies described herein provide encapsulated liquid- like Nanoparticle Organic Hybrid Materials (NOHMs) solid sorbents composed of a silica nanoparticle and alkyl amine (i.e., polyethyleneimine, PEI, or tetraethylpentamine, TEPA) or PEI and TEPA alone, within electrospun nanofibers made of porous and hydrophobic polymers (PIM) and ceramic-like materials (PAN-OPSZ). NOHMs sorbents have been demonstrated to be highly stable and tunable for CO₂ capture and have negligible vapor pressure, but their main drawbacks are high viscosity and high gas transfer limitation in their neat bulk phase. To mitigate these problems, gas-assisted electrospinning processing coupled with an encapsulation matrix, such as Polymers with Intrinsic Microporosity (PIM-1) and polyacrylonitrile (PAN)/organopolysilazane (OPSZ) polymer/ceramic hybrid materials, was used to generate a carrier system (sheath) for the active NOHMs or amines, PEI or TEPA, sorbents. These encapsulation materials were evaluated for their thermal stability, hydrophobicity, permeability, and CO₂ selectivity. The manufacturing parameters, such as component composition and processing solvent, were linked to bulk sorbent properties, e.g., surface area, pore volume, fiber thickness, capture capacity, and capture kinetics. The nanofiber mat contactor design can potentially yield significantly reduced pressure drop and high scalability up to large modular air filters.

### Electrospinning

An exemplary electrospinning process is schematically depicted in FIG. 10. To form the electrospinning solutions, solid precursors were added to a 20 mL scintillation vial. The solvent was charged via micropipette, and the solution was stirred at room temperature until complete homogenization was observed. The electrospinning solution was drawn into a BD Plastic-Pak 5 mL syringe and loaded into a Harvard Apparatus syringe pump, and a custom 90° three-way Luer-Lock adapter with inset needle was attached. The high-voltage lead was connected to the needle, and the air line was fastened to the 90° connection. A metal collector plate was covered in aluminum foil, grounded, and placed at a predetermined distance from the needle. Extrusion was performed with a constant flow rate and air pressure until the desired volume of solution was deposited. Coaxial spinning was achieved by adding a second syringe pump and tube connection with Luer-Lock fittings in place of the air sheath.

### NOHMs Sorbent Synthesis

NOHM-I-PEI was prepared by protonating the silica core and by tethering the polymer chains onto the functionalized silica nanoparticles. First, 20.5 g of silica suspension was added to 81 mL of deionized water and stirred until homogeneous. To exchange the Na⁺ ions of the silica with H⁺ ions, the mixture was run four times through the column filled with 75 g of ion exchange resin. The obtained suspension was kept overnight in a beaker covered with parafilm. The next day, 30 g of PEI was diluted in 150 mL of deionized water. The PEI aqueous solution was then added in a dropwise manner to the silica nanoparticles suspension while stirring.

NOHM-I-TEPA was synthesized by ionically tethering tetraethylenepentamine onto a silica core. First, a silica nanoparticle solution was prepared by dissolving 20.5 g of LUDOX in 136 mL of DI water. Then, the solution was run through the column full of cation exchange resin to protonate the silica core. The mixture was kept under stirring overnight and then the next day. The next day, PEI was dissolved in DI water and mixed until homogenous. Then, the PEI solution was put into the protonated silica solution in a dropwise manner. The mixture was stirred for a few hours and then put into the vacuum oven at 75° C. to remove volatile species.

### PIM-1 Synthesis

PIM-1 was formed from the polycondensation of precursor 5,5′,6,6′-tetrahydroxy-3,3,3′,3′-tetramethyl-1,1′-spirobisindane (TTSBI) and tetrafluoroterephthalonitrile (TFTPN). PIM-1 reacts at 65° C. for 3 days, and PIM-2 reacts at 100° C. for 24 hours. Each PIM was purified through recrystallization and precipitations. Reaction time and temperature were optimized to achieve the desired molecular weight.

### Materials Characterization

Gel Permeation Chromatography (GPC) was performed with tetrahydrofuran (THF) as the eluent. The PIM sample was dissolved in THE by stirring for 60 min, yielding a sample concentration of 1 mg PIM/1 mL THF. The sample was passed through a syringe filter (pore diameter of 0.2 um) before injection.

N₂ physisorption was performed to measure specific surface area and pore volume. Sample masses were determined by weighing the sample+tube immediately after analysis and subtracting out the mass of the empty tube. PIM-1 and PAN samples were degassed at 90° C. for 5 hrs under full vacuum (5 μm Hg), samples loaded with amine sorbent where degassed at 60° C. for 10 h. BET analysis was applied to data points within the low P/P0 region as determined by a monotonically increasing trend in the Rouquerol transform plot and linear slope on the BET transform. Pore size distributions were estimated using the NLDFT and HK models.

CO₂ working capacities were determined using a thermogravimetric analyzer. The fiber sample was first removed from its aluminum foil substrate and loaded into a TGA platinum pan. The sample was then pretreated with nitrogen or argon gas with increasing temperatures up to 80-110° C. (at a rate of 10° C./min). This temperature was maintained for 0.5-2 hours to remove any trapped or pre-absorbed CO₂ and volatile species that could not be removed from the vacuum dry oven. The temperature was then cooled down to room temperature, and CO₂ was introduced for the adsorption process. This procedure was repeated up to 15 times to investigate the long-term stability of the fiber.

Contact angle measurements were made using pure water as the liquid phase. A small square of fiber mat was cut from the bulk sample and mounted onto a plastic coverslip with double-sided tape. Using a 1 mL gas-tight syringe fitted with a vernier plunger, a drop of water (10-15 μL) was added to the fiber mat surface. The contact angle was recorded until the drop behavior was stabilized, typically at most one minute. Five measurements were taken per sample.

SEM images were taken using an accelerating voltage of 2 kV. Samples were mounted on an aluminum stub and grounded via conductive carbon tape and silver paint. Fibers were sputter-coated with a thin layer of Au/Pd to prevent sample charging. Cross-sectional samples were not as sputter-coated before imaging. Silicon mapping via Energy-Dispersive X-ray Spectroscopy (EDX) was performed using an X-ray detector at 6 kV accelerating voltage.

Cross-sectional microscopy was performed by embedding fiber samples in EMbed 812 epoxy resin and cured overnight at 60-80° C. 70-100 nm cross-sections were generated by microtomy on a diamond blade at a speed of 1.0 mm/s and supported on a copper TEM grid with hexagonal supports spaced at 200 grids per inch. Cross-sections were negatively stained with uranyl acetate (UA) by exposing the grids to a drop of 1.5% aqueous UA solution for 15 minutes, followed by three washes with distilled water. All samples were plasma cleaned for 45 seconds prior to imaging. TEM brightfield images were taken using a 50 μm aperture, spot size of 3, and an accelerating voltage of 200 kV.

### Synthesis and Tuning of NOHMs

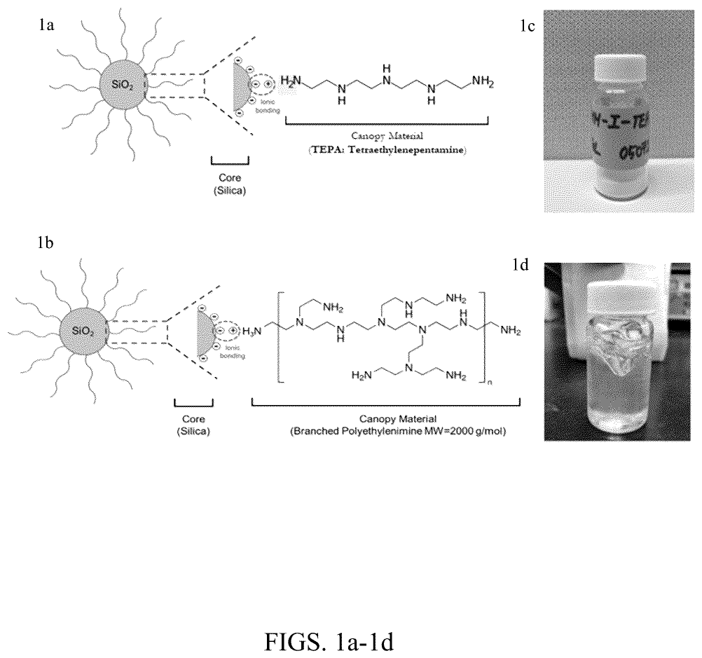

Two types of NOHMs were used as the active sorbent materials to be encapsulated: NOHM-I-PEI and NOHM-I-TEPA. Tetraethylenepentamine (TEPA) is a linear chain with a shorter length and a lower amine density, while PEI is a much longer, branched chain with higher amine density. This affects the phase of the neat material; NOHM-I-PEI possesses a highly-viscous liquid-like phase, while NOHM-I-TEPA exists as solid particles. The structures of NOHM-I-PEI and NOHM-I-TEPA are shown in FIGS. 1a-1b.

### Synthesis and Tuning of PIM-1

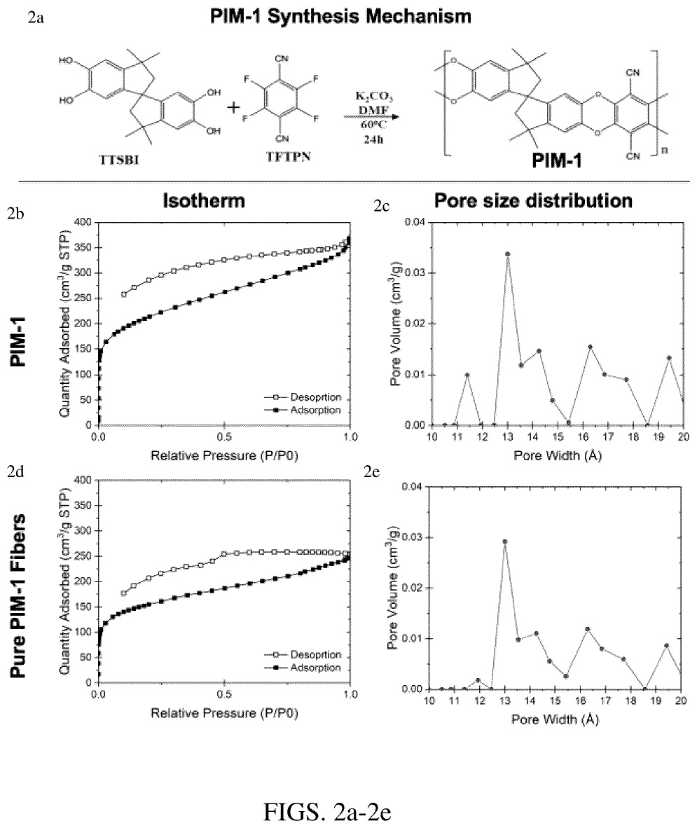

As schematically shown in FIG. 2a, PIM-1 was successfully synthesized via polycondensation of precursor TTSBI and TFTPN. The reaction time and temperature were varied to yield molecular weights ranging from 80 kDa to 200 kDa. A molecular weight of ˜100 kDa was determined to be optimal for electrospinning processing in THF solvent. As shown in FIGS. 2b-2e, N₂ sorption isotherms were obtained to measure the specific surface area and pore size distribution of as-synthesized PIM-1 powder as well as electrospun PIM-1 fibers, which confirmed the presence and retention of high specific surface area and microporous nature of PIM-1 before and after electrospinning.

### PIM-1 Composite Fibers: Internal Distribution of NOHMs Sorbent

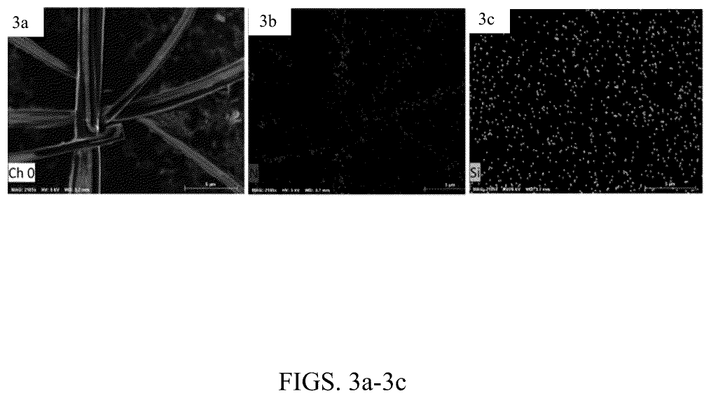

PIM-1 was successfully used as an encapsulation material for composite fibers containing various NOHM sorbents with PEI and TEPA, and PEI and TEPA alone, silicon and nitrogen distribution using SEM and Energy-Dispersive Spectroscopy were preformed. The results are shown in FIGS. 3a-3c.

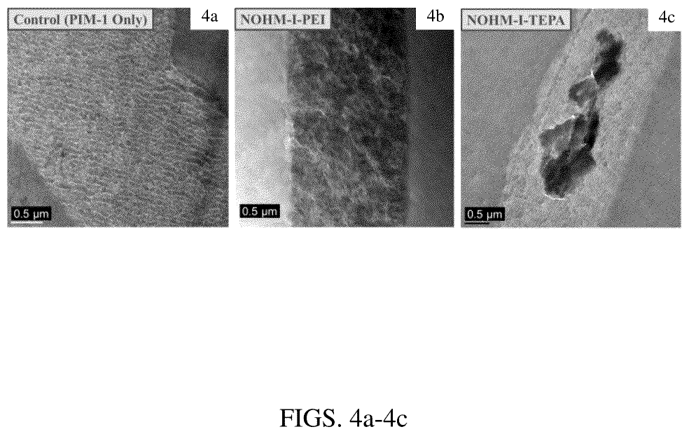

A more direct method to view the spatial distribution of NOHMs within the fiber was to expose the cross-section and then use Transmission Electron Microscopy (TEM). Upon microtoming, negative staining, and imaging the fiber cross-sections, distinct differences were revealed in the internal structure between pure PIM-1 fibers (FIG. 4a), PIM-1/NIPEI composite fibers (FIG. 4b), and PIM-1/NITEPA composite fibers (FIG. 4c).

### PIM-1 Composite Fibers: Fiber Morphology, Capture Performance, and Hydrophobicity

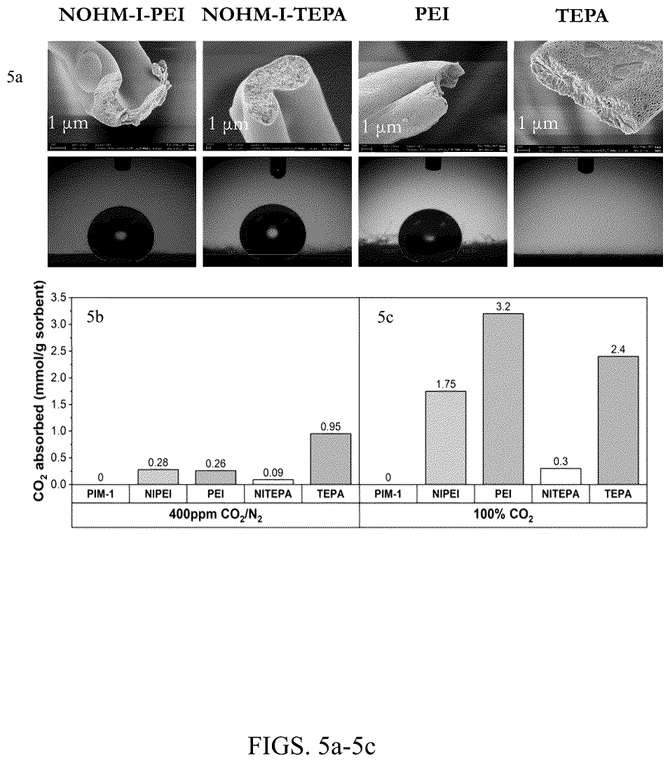

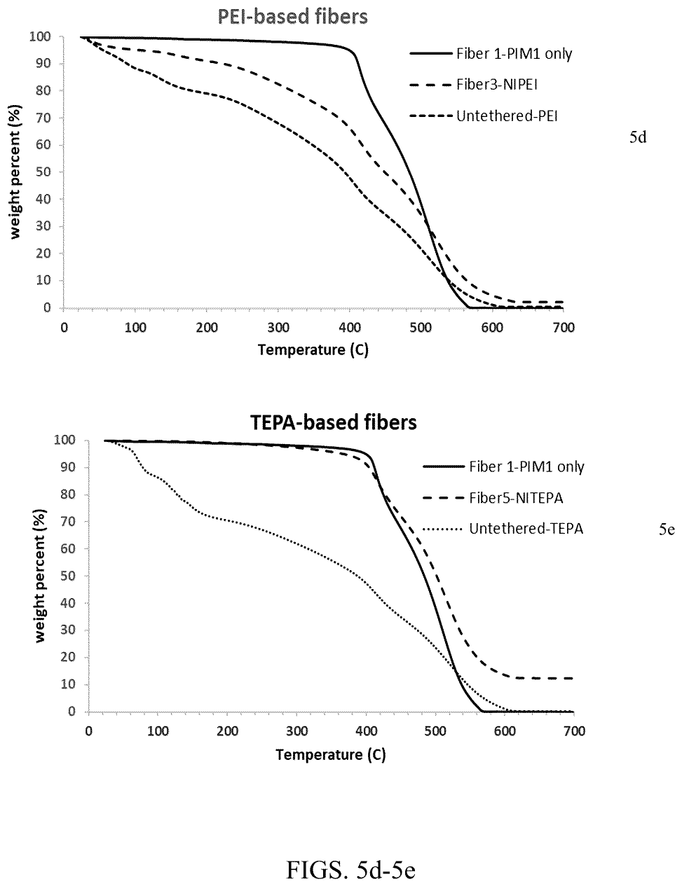

The composition of the various PIM-1/NOHM fibers affected their shape, hydrophobicity, and overall CO₂ capture performance. Pure PIM-1 fibers exhibited a dumb-bell shape with consistent widths of 5-10 μm and a thickness of around 1 μm. The surface was very smooth showing no porosity, despite the high surface areas (>400 m2/g) due to sub-2-nm microporosity from the molecular structure of PIM-1. The average contact angle for these fibers was 149.88±3.20°, right at the edge of superhydrophobicity. As shown in FIG. 5a, upon adding NIPEI, the overall fiber morphology remained flat and dumbbell-shaped, but with increased macroscale porosity (˜40 nm pore diameters), which may be due to phase separation between the PIM-1 and the NIPEI polyethyleneimine corona.

Fibers were also spun using the untethered PEI polymer. Since PEI is a viscous liquid (although with significantly lower viscosity than NIPEI), the same techniques were applied as performed with NIPEI. Again, the SEM images and contact angle measurement illustrate comparable behavior compared with the PIM-1/NIPEI fibers. Similar surface porosity was observed, and the macroscale morphology (˜10 μm dumbbell fibers) was preserved (FIG. 5a). The 126.71±5.39° average contact angle for these PIM-1/PEI fibers was slightly lower than both the pure PIM-1 and the PIM-1/NIPEI derivative.

PIM-1/NITEPA fibers required an additional processing step to reduce the large domain sizes of the NITEPA (>10 μm) via sonication. The effect of sonication was quite notable, as the average crystal size of NITEPA decreased significantly down to about 2 μm or less. The contact angle remained quite high, however, at 142.48±2.99°. Pure NITEPA has an angle of 0°, so the NITEPA domains were indeed completely encapsulated, despite the protruding morphology. PIM-1/untethered TEPA (a low-viscosity liquid) composite fibers were electrospun. While the typical ˜10 μm fiber macroscale morphology was preserved, the surface and internal cross-section showed significantly more porosity. However, the contact angle for these hybrid fibers was 0°, immediately soaking up the incident droplet. This suggested that there must be TEPA exposed on the surface, which most likely comprises the flat spots on the fiber surface (FIG. 5a).

Thermal decomposition experiments were performed to determine the composition of the fiber mats based on left over mass due to silica from the loaded NIPEI and NITEPA. Each TGA was run under air from 20-600° C. at a ramping rate of 10° C./min. TGA was also used to determine the pseudo-equilibrium capacities of CO₂ and 400 ppm CO₂ (in N₂). As shown in FIGS. 5b-5e, the fiber of PIM-1 with NIPEI vs PEI (no silica core), has approximately the same capacity with 400 ppm CO₂ performance at 0.28 and 0.26 mmol/g respectively. In pure CO₂, although the performance of PIM-TEPA fiber is extremely high at 2.4 mmol/g, the PIM-PEI fiber outperform all fibers at 3.2 mmol/g, and PIM-NITEPA is consistent as the lowest performer at 0.3 mmol/g.

### PAN/OPSZ Composite Fibers: Loading of NIPEI Sorbent vs. Fiber Morphology and Capture Performance

The second encapsulation system that was engineered uses polyacrylonitrile (PAN) with varying amounts of organopolysilazane (OPSZ) additive. Polyacrylonitrile (PAN) was also selected for future monoaxial spinning work due to its high molecular weight of 200 kDa, excellent solubility in DMF, and solvent compatibility with NOHM-I-PEI. Additionally, OPSZ is an excellent additive because of its lower surface tension and viscosity, which cause this component to migrate to the surface of the fiber. Interaction with atmospheric water and oxygen induces a curing process, wherein the methyl-functionalized —Si—N—Si— chain is converted via the evolution of ammonia to a —Si—O—Si— c chain. The formation of this ceramic layer then increases the hydrophobicity of the fibrous system.

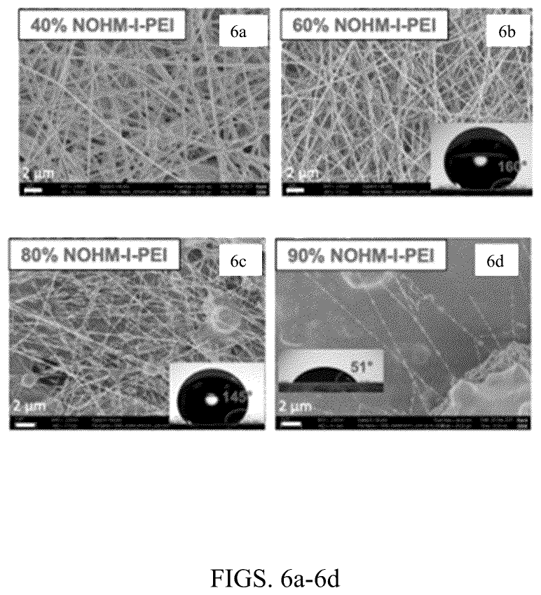

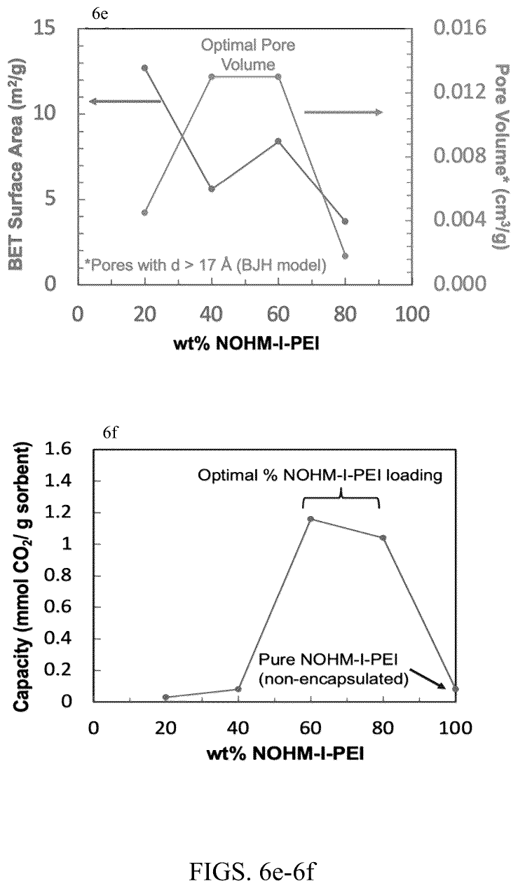

The maximum loading of NOHM-I-PEI within the PAN/OPSZ system before the fiber matrix can no longer fully encapsulate the hydrophilic NOHMs, leading to loss of water rejection potential was explored. To test this, the PAN:OPSZ ratio was fixed at 90:10, which was determined as the optimal ratio for low-concentration CO₂ uptake, and the total solid content was fixed at just under 10 wt %. The dissolved solid content was then partitioned between polymer matrix and NOHM-I-PEI from 0% NOHMs (pure matrix) up to 100% NOHMs (pure NOHM-I-PEI). As shown in FIGS. 6a-6d, SEM images of the electrospun fiber mats show that the fiber quality and dimensions were a strong function of the matrix concentration, which is itself a determining factor of the extent of hydrophobicity. As the NIPEI loading increased, it displaced the PAN/OPSZ matrix in solution, decreasing the percentage of PAN/OPSZ available to encapsulate the NIPEI. A noticeable decrease in the quality of the fibers at high NIPEI loadings and created significant NIPEI agglomeration and beading. Eventually, the fiber quality deteriorated sufficiently, such that the NIPEI domains were exposed on the fiber surface, instantly negating the hydrophobicity provided by the PAN/OPSZ matrix. This is observed in the sample with 90% NIPEI loading (10 wt % polymer matrix), which exhibited a contact angle of 51°, well into the hydrophilic range (FIG. 6d).

To quantitatively describe the fiber morphology, the BET surface area and pore volume were determined for this sample series. The results are shown in FIG. 6e. These values were analyzed in conjunction with the capture capacity under 400 ppm CO₂. Notably, the pore volume is a key parameter that determines the case of gas transport and therefore the extent of CO₂ chemisorption. As shown in FIG. 6f, at the sorbent loading that yielded the optimal capacity, the pore volume for the 60% loading is 4-5× higher than for the 80% loading. This optimal volume at 60% corresponded with the fibers with the highest CO₂ uptake.

### PAN/OPSZ Composite Fibers: Loading of OPSZ Additive vs. Fiber Morphology, Capture Performance, and Pressure Drop

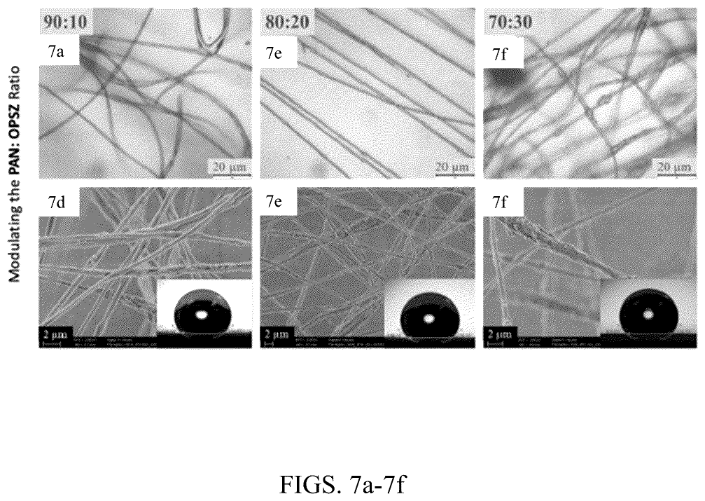

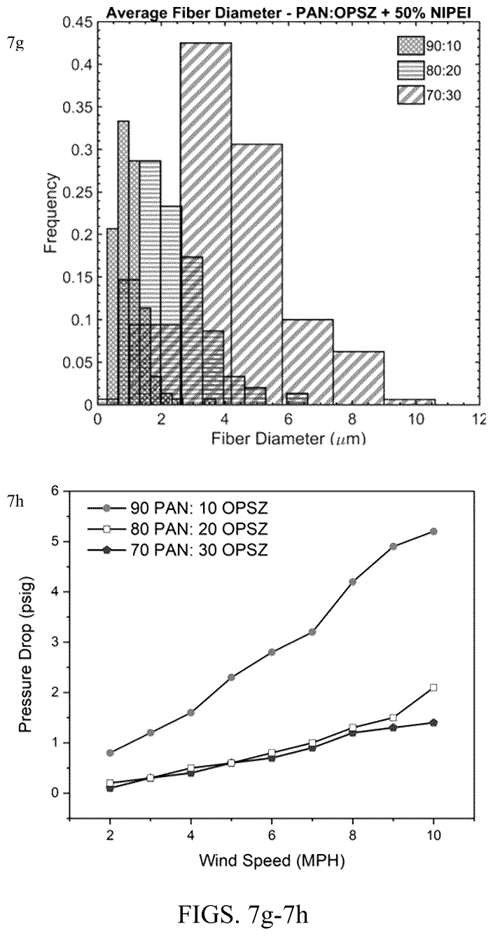

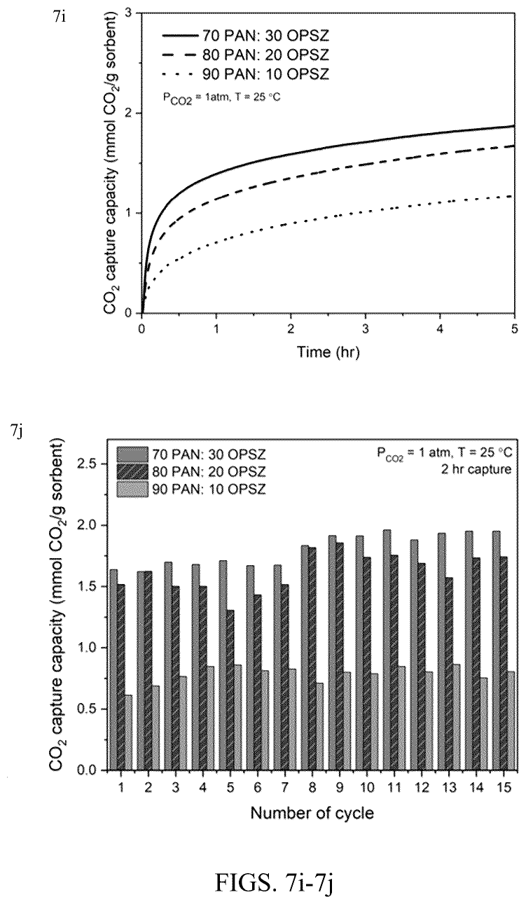

Another processing parameter that was adjusted was the loading of OPSZ additive. By mass, these fibers consisted of 50% polymer matrix and 50% NIPEI. As shown in the SEM images in FIGS. 7a-7f, in the 50% polymer matrix, the ratio between PAN and OPSZ was performed, which affected the fiber roughness, distribution of fiber diameters, capture performance, and pressure drop. The SEM images show that increasing the OPSZ loading from 10 wt % (i.e., 90:10 PAN:OPSZ) to 30 wt. % (i.e., 70:30 PAN:OPSZ) yielded rougher fiber surfaces, likely due to the increased thickness and reduced homogeneity of the OPSZ sheath layer (FIGS. 7a-7f). Adding higher than 30% OPSZ relative to PAN created significant beading on the fiber surface, enough OPSZ was present on the surface to coalesce into droplets.

The histogram of fiber diameters for each PAN/OPSZ ratio in FIG. 7g, a clear increase in both the average diameter and the distribution with increasing OPSZ concentration was observed. This result is attributed to the slight increase in dissolved solids as the ceramic ratio increases (18% at 90:10 to 23% at 70:30), which, in turn, slightly increases the solution viscosity. While this viscosity change is nearly imperceptible from a processing and electrospinning perspective, it is enough to affect the average diameter in the final product, increasing from 1.01±0.45 μm at 90:10 PAN:OPSZ to 4.45±1.82 μm at 70:30.

The macroscale pressure drop of different nanofiber mats was tested under air velocities ranging from 2 to 10 MPH, revealing a higher pressure drop with increasing simulated wind speeds. As shown in FIG. 7h, holding the areal loading constant at 2 mg/cm², the 90 PAN:10 OPSZ fibers yielded a 3-5× higher pressure drop than the 70 PAN:30 OPSZ fibers. The reduced pressure drop could be attributed to several reasons, most likely of these concerns the through-pore dimensions; i.e., the empty space between fibers. Since the void spaces generally scales with fiber diameter, electrospun mats with larger fiber diameters (e.g. the 70:30 PAN:OPSZ samples) will have larger through-pore spacing, which leads to a lower pressure drop.

Finally, higher OPSZ content was correlated to faster CO₂ capture kinetics and higher capacity. As shown in FIG. 7i, the 90:10, 80:20, and 70:30 PAN:OPSZ samples yielded pseudo-equilibrium capacities of 2.25, 3.34, and 3.73 mmol CO₂/g NIPEI at the 5 hr mark under pure CO₂, respectively. Multicycle testing (1 hr capture) revealed lower working capacity values, as expected. However, as shown in FIG. 7j, the average multicycle capacities for 10%, 20%, and 30% OPSZ loading were very stable at 0.79±0.07, 1.62±0.16, and 1.80±0.13, mmol CO₂/g sorbent, respectively, suggesting high thermal stability and sorbent cyclability.

### PAN/OPSZ Composite Fibers: Physicochemical Characterization

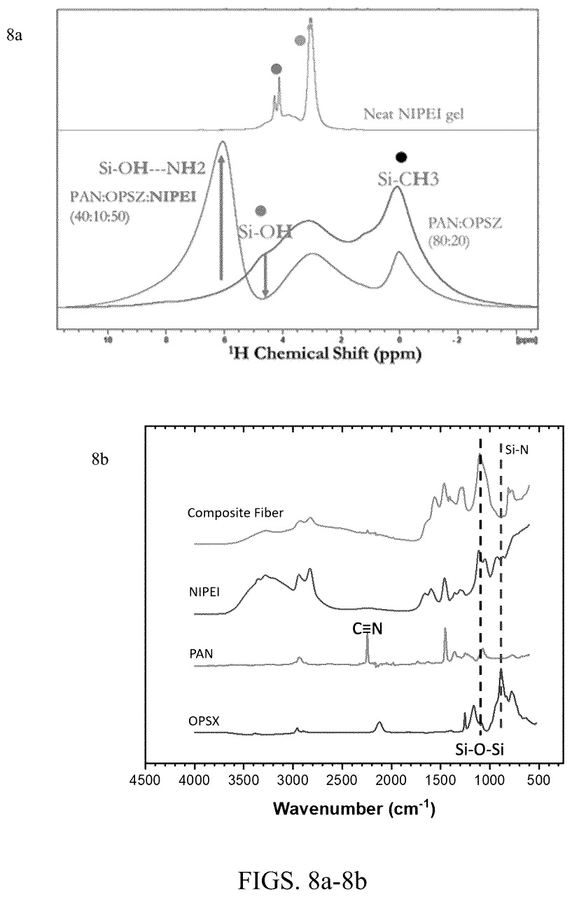

NMR and FT-IR spectroscopy were used to probe the molecular-level interactions among the various components within the composite PAN/OPSZ/NIPEI electrospun fibers. FIG. 8a, is an example of NIPEI before and after electrospinning using single-pulse solid-state ¹H NMR was performed, neat gel-like NIPEI (upper curve), PAN/OPSZ fiber without NIPEI (middle curve), and PAN/OPSZ fibers with NIPEI (lower curve). Comparing the chemical interactions of the electrospun fibers with and without NIPEI. Collectively, these observations suggest an interaction of the amine groups with the silica environments provided by the silica core and OPSZ, which is likely a synergetic effect that contributes to the high case of electrospinning and thermal oxidative stability of the composite fibers.

Next, as shown in FIG. 8b, FT-IR spectroscopy was performed on fibers PAN/OPSZ/NIPEI fibers to better understand if OPSZ cures under ambient conditions. Neat OPSZ is a silazane that contains Si—N bonds (˜880 cm⁻¹). These bonds are largely converted into Si−O−Si bonds (˜1100 cm⁻¹) after electrospinning into nanofibers, followed by curing in the ambient environment (FIG. 8b). Considering this is a complex mixed system, the OPSZ was still able to cure quickly under these conditions and on the electrospinning timescale.

### PAN/OPSZ Composite Fibers: CO₂ Breakthrough Tests

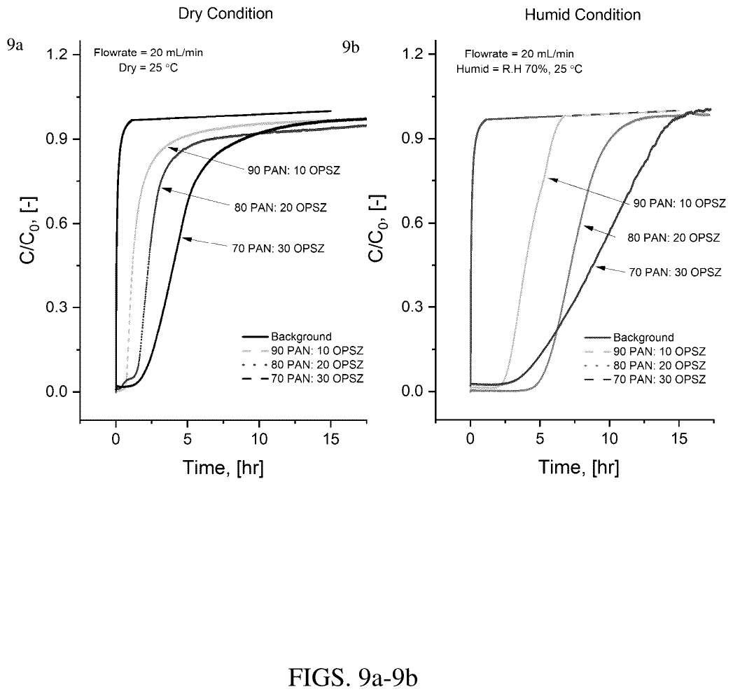

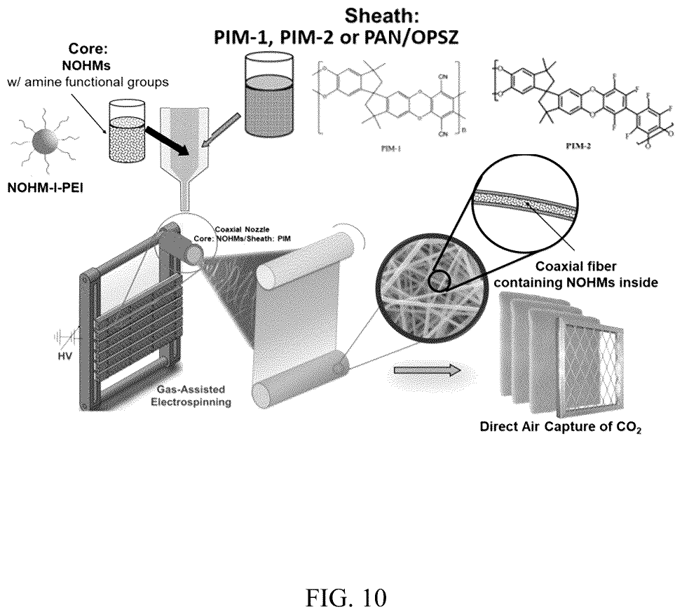

To understand the effect of humidity on CO₂ adsorption, breakthrough experiments were performed with a 400 ppm CO₂ gas stream at room temperature under dry and wet (70% R.H) conditions. The results are shown in FIGS. 9a and 9b. The calculated CO₂ uptakes were consistent with the CO₂ capture capacities obtained from the TGA for dry condition. Since the air contains moisture, the CO₂ capture performance was also investigated under humid conditions. Due to the formation of bicarbonates (as opposed to anhydrous carbonates) and participation of tertiary amines in the CO₂ capture mechanism when water is present, the CO₂ capture capacities all increased. However, the trend from breakthrough curves in the humid environments was different from that in dry conditions. While the 70 PAN:30 OPSZ fibers demonstrated the best CO₂ capture performance among all the fibers under dry conditions, 80 PAN:20 OPSZ fibers exhibited the highest CO₂ capture capacity in humid conditions. The amount of ceramic material in the shell composites could have created the optimal diffusion routes for H₂O to aid the CO₂ capture mechanism.

The technologies described herein generated significant data illustrating the benefits of electrospun, microporous polymer fiber-encapsulation of PEI, TEPA and NOHMs for Direct Air Capture. The DAC materials described herein provide highly robust DAC operations with long-term stability required to reduce the cost of DAC. The results described herein demonstrate the successful encapsulation of both linear and branched amines, TEPA and PEI, and liquid-like Nanoparticle Organic Hybrid Materials (NOHMs) viscous sorbents within electrospun nanofibers made of various porous and hydrophobic polymers and ceramic materials. In the past, NOHMs sorbents have been demonstrated to be highly stable and tunable for CO₂ capture and have negligible vapor pressure, but their main drawbacks have been high viscosity, high hydrophobicity and high mass transfer limitations in their neat bulk phase. To overcome these drawbacks, gas-assisted electrospinning processing coupled with promising encapsulation matrices such as Polymers with Intrinsic Microporosity (PIM-1) and polyacrylonitrile (PAN)/organopolysilazane (OPSZ) polymer/ceramic hybrid materials was herein developed. These encapsulation materials were evaluated by their thermal stability, hydrophobicity, permeability, and CO₂ selectivity. The manufacturing parameters, such as component composition and processing solvent, were linked to bulk sorbent properties, e.g., surface area, pore volume, fiber thickness, capture capacity, capture kinetics, etc. which enabled CO₂ selectivity, gas permeability through the sheath, overcame mass transport and diffusion limitations, and induced hydrophobicity decreased regeneration energy penalties. Moreover, the nanofiber mat contactor design can be scaled up and exhibit the ability to overcome significant pressure drop issues and increased performance of large modular air filters.

While there have been shown and described what are at present considered the preferred embodiments of the invention, those skilled in the art may make various changes and modifications which remain within the scope of the invention defined by the appended claims.

1. An encapsulated fiber composition comprising:
(i) a lengthwise core portion of the fiber comprising an amine-containing material for adsorbing carbon dioxide; and
(ii) a lengthwise sheath portion of the fiber surrounding said lengthwise core portion, wherein the lengthwise sheath portion comprises a microporous polymer.

2. The composition of claim 1, wherein said amine-containing material comprises an organoamine molecule.

3. The composition of claim 2, wherein said organoamine molecule is selected from the group consisting of monoethanolamine, diethanolamine, N-methyldiethanolamine, diisopropylamine, triethanolamine, tetraethylpentamine, piperazine, homopiperazine, triethylene tetramine, diethylamine, diisopropylamine, tert-butylamine, 2-(t-butylamino) ethanol, pipecolic acid, piperidine, 2-piperidine-methanol, 2-piperidine-ethanol, 2-amino-2-methyl-1,3-propanediol, 2-amino-2-ethyl-1,3-propanediol, 2-amino-2-methyl-1-propanol, 1,8-p-menthanediamine, 2-amino-2-methylpropionic acid, 2-amino-2-phenylpropionic acid, polyethyleneimine, pyridine, pyrazine, guanidine-containing molecules, amine-containing polymers, and mixtures thereof.

4. The composition of claim 1, wherein said amine-containing material comprises a nanoparticle organic hybrid material (NOHM) containing a nanoparticle core attached to an amine-containing canopy.

5. The composition of claim 4, wherein the nanoparticle core comprises a metal oxide.

6. The composition of claim 5, wherein the metal oxide is silicon dioxide.

7. The composition of claim 4, wherein the amine-containing canopy comprises a molecule of the formula: H₂N—CH₂CH₂—NH—CH₂CH₂(NH—CH₂CH₂)ₙ—NH₂, wherein n is 0-12.

8. The composition of claim 4, wherein the amine-containing canopy comprises a branched polyethyleneimine.

9. The composition of claim 1, wherein the microporous polymer contains aromatic rings.

10. The composition of claim 1, wherein the microporous polymer contains a dibenzodioxane fused ring system.

11. The composition of claim 1, wherein the microporous polymer contains a spirobisindane system.

12. The composition of claim 1, wherein the microporous polymer comprises a polymer of intrinsic microporosity (PIM).

13. The composition of claim 12, wherein the PIM is PIM-1 or PIM-2.

14. The composition of claim 1, wherein the microporous polymer contains nitrile groups or fluorine groups.

15. The composition of claim 1, wherein the microporous polymer contains polyacrylonitrile (PAN).

16. The composition of claim 15, wherein the microporous polymer contains PAN and an organopolysilazane (OPSZ).

17. A method for capturing carbon dioxide, the method comprising contacting a source of carbon dioxide with an encapsulated fiber composition comprising:
(i) a lengthwise core portion of the fiber comprising an amine-containing material for adsorbing carbon dioxide; and
(ii) a lengthwise sheath portion of the fiber surrounding said lengthwise core portion, wherein the lengthwise sheath portion comprises a microporous polymer;
wherein said carbon dioxide is captured within the lengthwise core portion of the fiber.

18. The method of claim 17, wherein said source of carbon dioxide is air.

19. The method of claim 17, wherein said source of carbon dioxide is a combustion source.

20. The method of claim 17, wherein the amine-containing material comprises an organoamine molecule or a nanoparticle organic hybrid material (NOHM) containing a nanoparticle core attached to an amine-containing canopy.

21. The method of claim 17, wherein the microporous polymer comprises a polymer of intrinsic microporosity (PIM), PAN, or PAN:OPSZ.

22. The method of claim 21, wherein the PIM is PIM-1 or PIM-2.

23. The method of claim 1, wherein the composite of (i) and (ii) are electrospun into a fiber via mono, co, or tri-axially spinning methods.
